(19) United States
(12) Patent Application Publication
(10) Pub. No.: US 2026/0219789 A1
(43) Pub. Date: Jul. 30, 2026

(54) COMPUTE-IN-MEMORY DEVICES AND METHODS FOR OPERATING THE SAME

(71) Applicant: Taiwan Semiconductor Manufacturing Company, Ltd., Hsinchu (TW)

(72) Inventors: Hidehiro Fujiwara, Hsinchu City (TW); Xiaoyu Sun, Hsinchu City (TW); Haruki Mori, Hsinchu City (TW); Je-Min Hung, Hsinchu City (TW); Yu-Der Chih, Hsinchu City (TW); Jonathan Tsung-Yung Chang, Hsinchu City (TW)

(73) Assignee: Taiwan Semiconductor Manufacturing Company, Ltd., Hsinchu (TW)

(21) Appl. No.: 19/204,200

(22) Filed: May 9, 2025

Related U.S. Application Data
(60) Provisional application No. 63/749,374, filed on Jan. 24, 2025.

(51) Int. Cl. G06F 3/06

(52) U.S. Cl. CPC G06F 3/0613; G06F 3/0629; G06F 3/0673

(57) ABSTRACT

A memory circuit includes a plurality of memory cells arranged over a plurality of columns and a plurality of rows, wherein each of the plurality of memory cells is configured to store a corresponding one of a plurality of first data elements, wherein each of the columns includes a plural number of access lines; and a plurality of computation elements, wherein each of the plurality of computation elements is configured to generate a multiply-accumulate (MAC) value, the MAC value being formed based on (i) a pair of the first data elements respectively stored by a pair of the memory cells disposed in different ones of the rows and in a corresponding one of the columns and (ii) a pair of a plurality of second data elements. The pair of the first data elements are accessed through the plural access lines of the corresponding column.

### CROSS-REFERENCE TO RELATED APPLICATION

This application claims priority to and the benefit of U.S. Provisional Application Number 63/749,374, filed Jan. 24, 2025, which is incorporated herein by reference in its entirety for all purposes.

### BACKGROUND

With advances in modern day semiconductor manufacturing processes and the continually increasing amounts of data generated each day, there is an ever greater need to store and process large amounts of data, and therefore a motivation to find improved ways of storing and processing large amounts of data. Although it is possible to process large quantities of data in software using conventional computer hardware, existing computer hardware can be inefficient for some data-processing applications.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example neural network, in accordance with some embodiments.

FIG. 2 illustrates a block diagram of a memory system, in accordance with some embodiments.

FIG. 3 illustrates an example schematic diagram of a memory bank of the memory system of FIG. 2, in accordance with some embodiments.

FIG. 4 illustrates another example schematic diagram of a memory bank of the memory system of FIG. 2, in accordance with some embodiments.

FIG. 5 illustrates yet another example schematic diagram of a memory bank of the memory system of FIG. 2, in accordance with some embodiments.

FIG. 6 illustrates yet another example schematic diagram of a memory bank of the memory system of FIG. 2, in accordance with some embodiments.

FIGS. 7 and 8 illustrate alternative embodiments of block diagrams of the memory system of FIG. 2, respectively, in accordance with some embodiments.

FIG. 9 illustrate a flow chart of an example method for operating a memory system implementing CIM technique, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In this regard, machine learning has emerged as an effective way to analyze and derive value from such large quantities of data. Generally, machine learning is a field of computer science that involves algorithms that allow computers to “learn” (e.g., improve performance of a task) without being explicitly programmed. Machine learning can involve different techniques for analyzing data to improve upon a task. One such technique (such as deep learning) is based on neural networks. However, machine learning performed on conventional computer systems can involve excessive data transfers between memory and the processor, leading to high power consumption and slow compute times.

Compute-In-Memory (CIM) (which can also be referred to as in-memory processing) involves performing compute operations within a memory array. Stated another way, compute operations are performed directly on the data read from the memory cells instead of transferring the data to a digital processor for processing. By avoiding transferring some data to the digital processor, the bandwidth limitations associated with transferring data back and forth between the processor and memory in a conventional computer system are reduced.

One application for such a CIM is artificial intelligence (AI), and specifically machine learning. For example, a computing system (e.g., a CIM system) can use multiple layers of computational nodes, where lower layers perform computations based on results of computations performed by higher layers. These computations sometimes may rely on the computation of dot-products and absolute difference of vectors, typically computed with MAC (operations) performed on the parameters, input data and weights. The term “MAC” can refer to multiply-accumulate, multiplication/accumulation, or multiplier accumulator, in general referring to an operation that includes the multiplication of two values, and the accumulation of a sequence of multiplications.

The present disclosure provides various embodiments of a CIM system that can efficiently output a number of MAC values with a significantly high write bandwidth. For example, the CIM system, as disclosed herein, can include at least one memory array (e.g., arranged in a single memory bank or across multiple memory banks) with a plural number of memory cells. The memory cells can be arranged over a plural number of rows and a plural number of columns. In some embodiments, each of the columns can include a plural number of access lines (e.g., bit lines BLs), in which each of the access lines is configured to concurrently access (e.g., write) a plural number of memory cells. As a representative example, each column of the memory array can include a first bit line and a second bit line, where the first bit line can be configured to write a first data element to a first memory cell along that column and the second bit line can be configured to write a second data element to a second memory cell along that column. The write operation to program (or update) the first and second memory cells can be performed concurrently. Further, in some embodiments, the first memory cell and the second memory cell can be operatively coupled to a first computation element and a second computation element, respectively. The first computation element can generate a first multiply-accumulate (MAC) value based on the first data element and a third data element that is updated to a third memory cell through the second bit line, and the second computation element can generate a second MAC value based on the second data element and a fourth data element that is updated to a fourth memory cell through the first bit line. The first to fourth data elements can be concurrently programmed (or updated) into the first to fourth memory cells through the first and second bit lines. As such, a significantly large amount of data elements can be updated to the memory cells through the plural bit lines of a single column more efficiently.

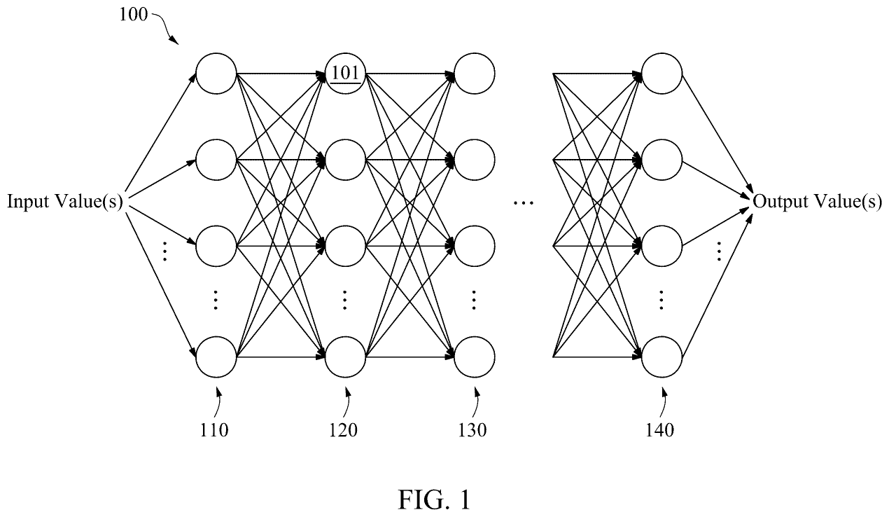

FIG. 1 illustrates an example neural network 100, in accordance with various embodiments. As shown, the neural network 100 includes four layers 110, 220, 130, and 140, where the layers 110 and 140 are referred to as an input layer and output layer, respectively, and the layers 220 to 130 are each referred to as a hidden layer. Each of the layers can include a number of neurons. In general, the hidden layers of the neural network 100 can largely be viewed as layers of neurons that each receive (e.g., weighted) outputs from the neurons of preceding layer(s) of neurons in a mesh-like interconnection structure between layers. The connection from the output of a particular preceding neuron to the input of another subsequent neuron is set according to the influence or effect that the preceding neuron is to have on the subsequent neuron (for simplicity, only one neuron 101 and the connections are labeled). In the illustrative example of FIG. 1, the output value of the preceding neuron is multiplied by the weight of its connection to the subsequent neuron to determine the particular stimulus that the preceding neuron presents to the subsequent neuron.

A neuron's total input stimulus corresponds to the combined stimulation of all of its weighted input connections. According to various implementations, if a neuron's total input stimulus exceeds some threshold, the neuron is triggered to perform some, e.g., linear or non-linear mathematical function on its input stimulus. The output of the mathematical function corresponds to the output of the neuron which is subsequently multiplied by the respective weights of the neuron's output connections to its following neurons.

Generally, the more connections between neurons, the more neurons per layer and/or the more layers of neurons, the greater the intelligence the network is capable of achieving. As such, neural networks for actual, real-world artificial intelligence applications are generally characterized by large numbers of neurons and large numbers of connections between neurons. Extremely large numbers of calculations (not only for neuron output functions but also weighted connections) are therefore involved in processing information through a neural network.

As mentioned above, although a neural network can be completely implemented in software as program code instructions that are executed on one or more traditional general purpose central processing unit (CPU) or graphics processing unit (GPU) processing cores, the read/write activity between the CPU/GPU core(s) and system memory that is needed to perform all the calculations is extremely intensive. The overhead and energy associated with repeatedly moving large amounts of read data from system memory, processing that data by the CPU/GPU cores and then writing resultants back to system memory, across the many millions or billions of computations needed to realize the neural network have not been entirely satisfactory in certain aspects.

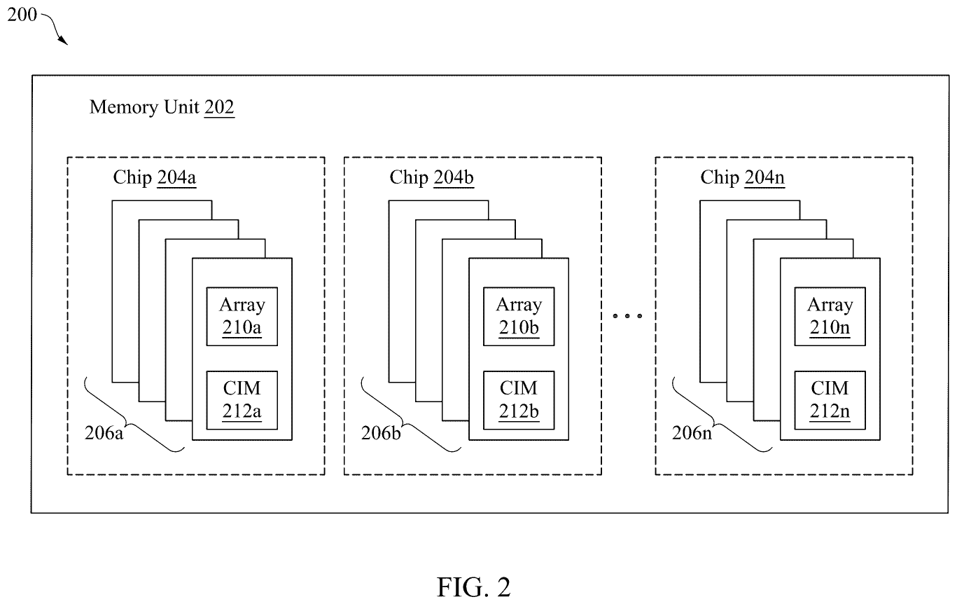

FIG. 2 illustrates an example memory system or memory circuit 200 employing CIM technology suitable for implementing various embodiments. While FIG. 2 illustrates one example of a memory system 200, it should be understood that additional components and/or elements may be added and existing components and/or element may be removed. Similarly, any such additional and existing components and/or elements may be combined and/or otherwise arranged. Additionally, the memory system 200 may form part of or be integrated in another computing device or system.

As illustrated, the memory system 200 may include a memory unit 202, in some embodiments. The memory unit 202 may include any number of memory chips 204a-204n. Each of the memory chips 204a-204n may include any number of memory banks. For example, the memory chip 204a can include one or more memory banks 206a, the memory chip 204a can include one or more memory banks 206b, and the memory chip 204n can include one or more memory banks 206n, etc. The memory banks 206a-206n include a number of memory arrays, e.g., 210a-210n and a number of CIM circuits, e.g., 212a-212n. In some embodiments, each of the memory arrays (e.g., 210a) may be operatively coupled to a corresponding one of the CIM circuits (e.g., 212a). Each of the memory arrays 210a-210n may include a respective number of memory cells arranged in columns and rows. Each of the memory cells may be configured to store a data element (e.g., a weight data element). The CIM circuits 212a-212n are each configured to implement operations (e.g., MAC operations) using the data elements stored at the corresponding one of the memory banks 206a-206n (or the corresponding one of the memory arrays 210a-210n), which will be described below.

In some embodiments, a single memory bank of each group of memory banks 206a-206n may be implemented across multiple memory chips 204a-204n. In other words, a single memory bank may be part of multiple groups of memory banks 206a-206n. As such, the memory arrays 210a-210n and CIM circuits 212a-212n for each of the memory banks 206a-206n may also be implemented across the multiple memory chips 204a-204n.

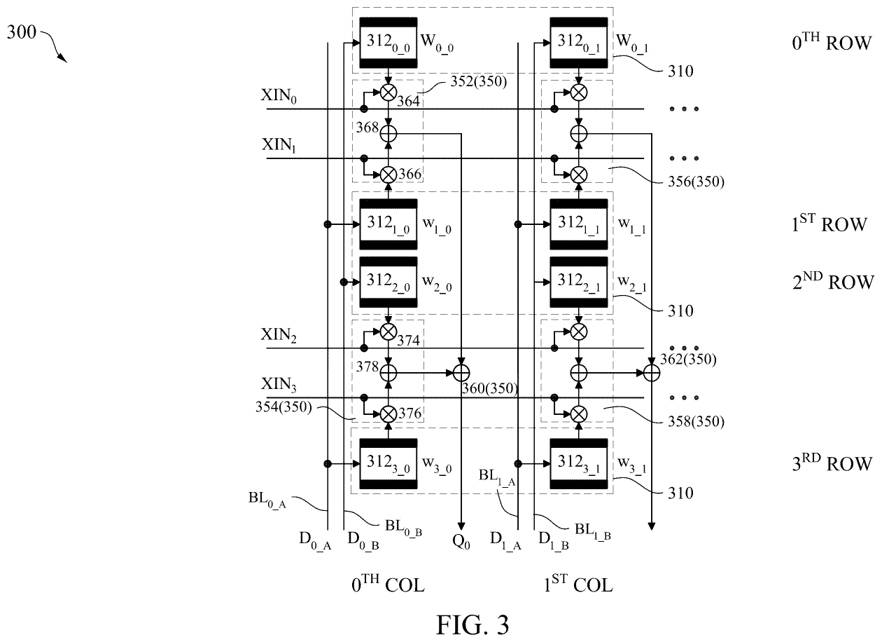

FIG. 3 illustrates a schematic diagram of a part of a memory bank (e.g., one of 206a-206n) including at least one memory array and at least one CIM circuit, which are configured to efficiently output a number of MAC values with a significantly high write bandwidth, in accordance with various embodiments. Hereinafter, the memory bank of FIG. 3 is referred to as a memory bank 300, with its memory array and CIM circuit referred to as memory array 310 and CIM circuit 350, respectively. It should be understood that the memory bank 300 is simplified for illustration purposes. Thus, memory bank 300 can include any of various other components, while remaining within the scope of present disclosure.

The memory array 310, in the illustrative example of FIG. 3, can include memory cells 312, e.g., 312_{0_0}, 312_{1_0}, 312_{2_0}, 312_{3_0}, 312_{0_1}, 312_{1_1}, 312_{2_1}, and 312_{3_1}. Although eight memory cells 312 are shown, it should be understood that the memory array 310 can include any number of the memory cells 312 while remaining within the scope of the present disclosure. Further, even though each of the blocks 312_{0_0} to 312_{3_1} in FIG. 3 refers to a single memory cell, it should be understood that each of the blocks can refer to a subset of memory cells. In some embodiments, the memory cell 312 includes a static random-access memory (SRAM) cell, where each SRAM cell can be configured as a five-transistor (5T) SRAM cell, a six-transistor (6T) SRAM cell, an eight-transistor (8T) SRAM cell, a nine-transistor (9T) SRAM cell, or an SRAM cell having other numbers of transistors. In some other embodiments, the memory cell 312 includes a dynamic random-access memory (DRAM) cell or other memory cell types capable of storing a data element.

The memory cells 312_{0_0} to 312_{3_1} may be arranged over a number of columns (extending along a first lateral direction) and a number of rows (extending along a second lateral direction). For example, the memory cells 312_{0_0} and 312_{0_1} are commonly arranged in 0^{th} row and respectively arranged along 0^{th} column and 1^{st} column; the memory cells 312_{1_0} and 312_{1_1} are commonly arranged in 1^{th} row and respectively arranged along the 0^{th} column and 1^{st} column; the memory cells 312_{2_0} and 312_{2_1} are commonly arranged in 2^{nd} row and respectively arranged along the 0^{th} column and 1^{st} column; and the memory cells 312_{3_0} and 312_{3_1} are commonly arranged in 3^{rd} row and respectively arranged along the 0^{th} column and 1^{st} column. In some embodiments, each of the memory cells 312_{0_0} to 312_{3_1} is configured to store a data element (e.g., a weight data element), and the data elements stored by different memory cells of each column can be updated concurrently through its plural access lines (e.g., bit lines), which will be discussed below.

In some embodiments, each of the columns includes a plural number (e.g., 2) of bit lines, and each of the plural bit lines is operatively coupled to a corresponding number (e.g., 2) of memory cells along that column. For example, in FIG. 3, the 0^{th} column includes bit lines BL_{0_A} and BL_{0_B}, where the bit line BL_{0_A} is operatively coupled to the memory cells 312_{1_0} and 312_{3_0}, and the bit line BL_{0_B} is operatively coupled to the memory cells 312_{0_0} and 312_{2_0}; and the 1^{st} column includes bit lines BL_{1_A} and BL_{1_B}, where the bit line BL_{1_A} is operatively coupled to the memory cells 312_{1_1} and 312_{3_1}, and the bit line BL_{1_B} is operatively coupled to the memory cells 312_{0_1} and 312_{2_1}. Further, in some embodiments, the memory cells coupled to the same bit line may be alternately arranged with respect to the memory cells coupled to the other bit line. Stated another way, the memory cells coupled to the same bit line may not be arranged in adjacent rows. For example, the memory cell 312_{0_0} and the memory cell 312_{2_0}, coupled to the same bit line BL_{0_B}, are arranged in the 0^{th} row and the 2^{nd} row, respectively.

In some embodiments, the bit lines are each configured to apply a data element (e.g., a weight data element) concurrently to the coupled memory cells, causing the memory cells to be concurrently updated with the latest data element. As such, a write bandwidth of the memory bank 300 (or the corresponding memory circuit as a whole) can be greatly improved. For example, the bit line BL_{0_A} can apply a data element D_{0_A} to the memory cells 312_{1_0} and 312_{3_0}, and the bit line BL_{0_B} can apply a data element D_{0_B} to the memory cells 312_{0_0} and 312_{2_0}. As such, weight data elements W_{0_0}, W_{1_0}, W_{2_0}, and W_{3_0} respectively stored by the memory cells 312_{0_0}, 312_{1_0}, 312_{2_0}, and 312_{3_0} can be updated to D_{0_B}, D_{0_A}, D_{0_B}, and D_{0_A}, in which at least the update on the memory cells 312_{0_0} and 312_{2_0} can concurrently occur, and the update on the memory cells 312_{1_0} and 312_{3_0} can concurrently occur. Similarly, the bit lines BL_{1_A} can apply a data element D_{1_A} to the memory cells 312_{1_1} and 312_{3_1}, and the bit line BL_{1_B} can apply a data element D_{1_B} to the memory cells 312_{0_1} and 312_{2_1}. As such, weight data elements W_{0_1}, W_{1_1}, W_{2_1}, and W_{3_1} respectively stored by the memory cells 312_{0_1}, 312_{1_1}, 312_{2_1}, and 312_{3_1} can be updated to D_{1_B}, D_{1_A}, D_{1_B}, and D_{1_A}, in which at least the update on the memory cells 312_{0_1} and 312_{2_1} can concurrently occur, and the update on the memory cells 312_{1_1}and 312_{3_1} can concurrently occur.

The CIM circuit 350, in the illustrative example of FIG. 3, can include a number of computation elements 352, 354, 356, ad 358. Each of the computation elements 352 to 358 may include at least two multipliers and one adder. A first one of the multipliers is configured to multiply a first weight data element retrieved from a first memory cell with a first input data element to generate a first product, a second one of the multipliers is configured to multiply a second weight data element retrieved from a second memory cell with a second input data element to generate a second product, and the adder is configured to sum up the first and second product to generate a MAC value. In some embodiments, the first and second multipliers may be coupled to the memory cells, the weight data elements of which are updated through the different bit lines. Further, the CIM circuit 350 can include a number of additional adders (e.g., 360, 362, etc.), each of which corresponds to a respective column of the memory array 310. This additional adder can sum up the MAC values respectively generated by the different computation elements along the same column.

For example, the computation element 352 includes multipliers 364 and 366, and an adder 368. The multiplier 364 can multiply the weight data element W_{0_0} stored in the memory cell 312_{0_0} by input data element XIN₀ to generate a first product, the multiplier 366 can multiply the weight data element W_{1_0} stored in the memory cell 312_{1_0} by input data element XIN₁ to generate a second product, and the adder 368 can sum up the first and second products to generate a first MAC value. Similarly, the computation element 354 includes multipliers 374 and 376, and an adder 378. The multiplier 374 can multiply the weight data element W_{2_0} stored in the memory cell 312_{2_0} by input data element XIN₂ to generate a third product, the multiplier 376 can multiply the weight data element W_{3_0} stored in the memory cell 312_{3_0} by input data element XIN₃ to generate a fourth product, and the adder 378 can sum up the third and fourth products to generate a second MAC value.

Upon the first and second MAC values being generated by the computation elements 352 and 354, respectively, the additional adder 360 can sum up the first and second MAC values to generate an output Q₀ which may be a partial sum. In some embodiments, the additional adder 360 can generate the output Q₀ by adding the MAC values generated by other computation elements coupled to the 0^{th} column. Following the same principle, each of the other columns of the memory array 310, together with one or more corresponding computation elements of the CIM circuit 350, can generate a respective output (partial sum) Q. For example, the 1^{st} column can cause a respective output (partial sum) Q₁ to be generated by at least the adder 362. Although not shown, it should be understood that the CIM circuit 350 can include at least yet another adder to sum up those partial sums from respective columns (e.g., Q₀, Q₁, etc.) to generate another partial sum.

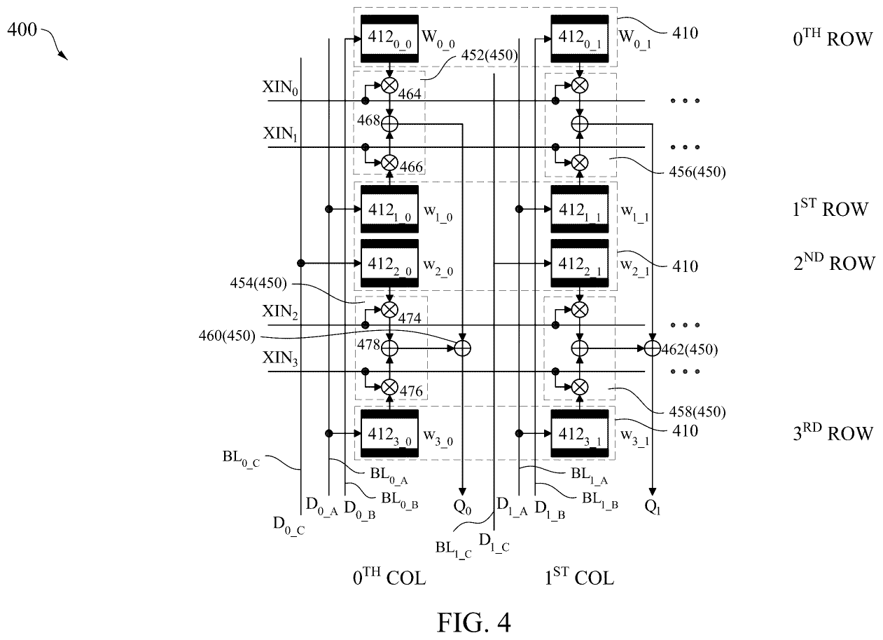

FIG. 4 illustrates a schematic diagram of a part of a memory bank (e.g., one of 206a-206n) including at least one memory array and at least one CIM circuit, which are configured to efficiently output a number of MAC values with a significantly high write bandwidth, in accordance with various embodiments. Hereinafter, the memory bank of FIG. 4 is referred to as a memory bank 400, with its memory array and CIM circuit referred to as memory array 410 and CIM circuit 450, respectively. The memory bank 400 is substantially similar to the memory bank 300 (FIG. 3), except that each column of the memory array 410 includes 3 bit lines, and each of these bit lines can be coupled to 3 memory cells. Accordingly, the following discussion will be focused on the difference.

The memory array 410, in the illustrative example of FIG. 4, can include memory cells 412, e.g., 412_{0_0}, 412_{1_0}, 412_{2_0}, 412_{3_0}, 412_{0_1}, 412_{1_1}, 412_{2_1}, and 412_{3_1}, which are arranged over 2 columns (0^{th} column and 1^{st} column) and 4 rows (0^{th} row, 1^{st} row, 2^{nd} row, and 3^{rd} row). Each of the memory cells can be configured as an SRAM cell, a DRAM cell, or other memory cell type capable of storing a data element. For example, each of the memory cells can store a weight data element, and the respective weight data elements of multiple memory cells along each column can be concurrently updated through the multiple bit lines of that column.

In some embodiments, each of the columns includes 3 bit lines, and each of these 3 bit lines is operatively coupled to 3 memory cells along that column. For example, in FIG. 4, the 0^{th} column includes bit lines BL_{0_A}, BL_{0_B}, and BL_{0_C}, where the bit line BL_{0_A} is operatively coupled to the memory cells 412_{1_0} and 412_{3_0} and another memory cell 412 (not shown in FIG. 4), the bit line BL_{0_B} is operatively coupled to the memory cells 412_{0_0} and other two memory cells 412 (not shown in FIG. 4), and the bit line BL_{0_C} is operatively coupled to the memory cells 412_{2_0} and other two memory cells 412 (not shown in FIG. 4). Still in FIG. 4, the 1^{st} column includes bit lines BL_{1_A}, BL_{1_B}, and BL_{1_C}, where the bit line BL_{1_A} is operatively coupled to the memory cells 412_{1_1} and 412_{3_1} and another memory cell 412 (not shown in FIG. 4), the bit line BL_{1_B} is operatively coupled to the memory cells 412_{0_1} and other two memory cells 412 (not shown in FIG. 4), and the bit line BL_{1_C} is operatively coupled to the memory cells 412_{2_1} and other two memory cells 412 (not shown in FIG. 4). Further, in some embodiments, the memory cells coupled to the same bit line may be alternately arranged with respect to the memory cells coupled to the other bit lines. Stated another way, the memory cells coupled to the same bit line may not be arranged in adjacent rows. For example, the memory cell 412_{1_0} and the memory cell 412_{3_0}, coupled to the same bit line BL_{0_A}, are arranged in the 1^{th} row and the 3^{rd} row, respectively.

In some embodiments, the bit lines are each configured to apply a data element (e.g., a weight data element) concurrently to the coupled memory cells, causing the memory cells to be concurrently updated with the latest data element. As such, a write bandwidth of the memory bank 400 (or the corresponding memory circuit as a whole) can be greatly improved. For example, the bit line BL_{0_A} can apply a data element D_{0_A} to the memory cells 412_{1_0} (1^{st} row), 412_{3_0} (3^{rd} row), and another memory cell 412 that may be disposed in 5^{th} row (not shown); the bit line BL_{0_B} can apply a data element D_{0_B} to the memory cells 412_{0_0} (0^{th} row) and other two memory cells 412 that may be respectively disposed in 4^{th} row and 7^{th} row (not shown); and the bit line BL_{0_C} can apply a data element D_{0_C} to the memory cells 412_{2_0} (2^{nd} row) and other two memory cells 412 that may be respectively disposed in 6^{th} row and 8^{th} row (not shown).

As such, weight data elements W_{0_0}, W_{1_0}, W_{2_0}, and W_{3_0} respectively stored by the memory cells 412_{0_0}, 412_{1_0}, 412_{2_0}, and 412_{3_0} can be updated to D_{0_B}, D_{0_A}, D_{0_c}, and D_{0_A}. Further, at least the update on the memory cells 412_{0_0} and other two memory cells 412 coupled to the bit line BL_{0_B}along the 0^{th} column can concurrently occur; the update on the memory cell 412_{1_0}, 412_{3_0}, and another memory cell 412 coupled to the bit line BL_{0_A} along the 0^{th} column can concurrently occur; and the update on the memory cell 412_{2_0} and other two memory cells 412 the bit line BL_{0_C} along the 0^{th} column can concurrently occur. Similarly, the bit lines BL_{1_A} can apply a data element D_{1_A} to the memory cells 412_{1_1}, 412_{3_1}, and another memory cell 412 along the 1^{st} column; the bit line BL_{1_B} can apply a data element D_{1_B} to the memory cells 412_{0_1} and other two memory cells 412 along the 1^{st} column; and the bit line BL_{1_C} can apply a data element D_{1_C} to the memory cells 412_{2_1} and other two memory cells 412 along the 1^{st} column.

The CIM circuit 450, in the illustrative example of FIG. 4, can include a number of computation elements 452, 454, 456, and 458. Each of the computation elements 452 to 458 may include at least two multipliers and one adder. A first one of the multipliers is configured to multiply a first weight data element retrieved from a first memory cell with a first input data element to generate a first product, a second one of the multipliers is configured to multiply a second weight data element retrieved from a second memory cell with a second input data element to generate a second product, and the adder is configured to sum up the first and second product to generate a MAC value. In some embodiments, the first and second multipliers may be coupled to the memory cells, the weight data elements of which are updated through the different bit lines. Further, the CIM circuit 450 can include a number of additional adders (e.g., 460, 462, etc.), each of which corresponds to a respective column of the memory array 410. This additional adder can sum up the MAC values respectively generated by the different computation elements along the same column.

For example, the computation element 452 includes multipliers 464 and 466, and an adder 468. The multiplier 464 can multiply the weight data element W_{0_0} stored in the memory cell 412_{0_0} by input data element XIN₀ to generate a first product, the multiplier 466 can multiply the weight data element W_{1_0} stored in the memory cell 412_{1_0} by input data element XIN₁ to generate a second product, and the adder 468 can sum up the first and second products to generate a first MAC value. Similarly, the computation element 454 includes multipliers 474 and 476, and an adder 478. The multiplier 474 can multiply the weight data element W_{2_0} stored in the memory cell 412_{2_0} by input data element XIN₂ to generate a third product, the multiplier 476 can multiply the weight data element W_{3_0} stored in the memory cell 412_{3_0} by input data element XIN₃ to generate a fourth product, and the adder 478 can sum up the third and fourth products to generate a second MAC value.

Upon at least the first and second MAC values being generated by the computation elements 452 and 454, respectively, the additional adder 460 can sum up the first and second MAC values to generate an output Q₀ which may be a partial sum. In some embodiments, the additional adder 460 can generate the output Q₀ by adding the MAC values generated by other computation elements coupled to the 0^{th} column. Following the same principle, each of the other columns of the memory array 410, together with one or more corresponding computation elements of the CIM circuit 450, can generate a respective output (partial sum) Q. For example, the 1^{st} column can cause a respective output (partial sum) Q₁ to be generated by at least the adder 462. Although not shown, it should be understood that the CIM circuit 450 can include at least yet another adder to sum up those partial sums from respective columns (e.g., Q₀, Q₁, etc.) to generate another partial sum.

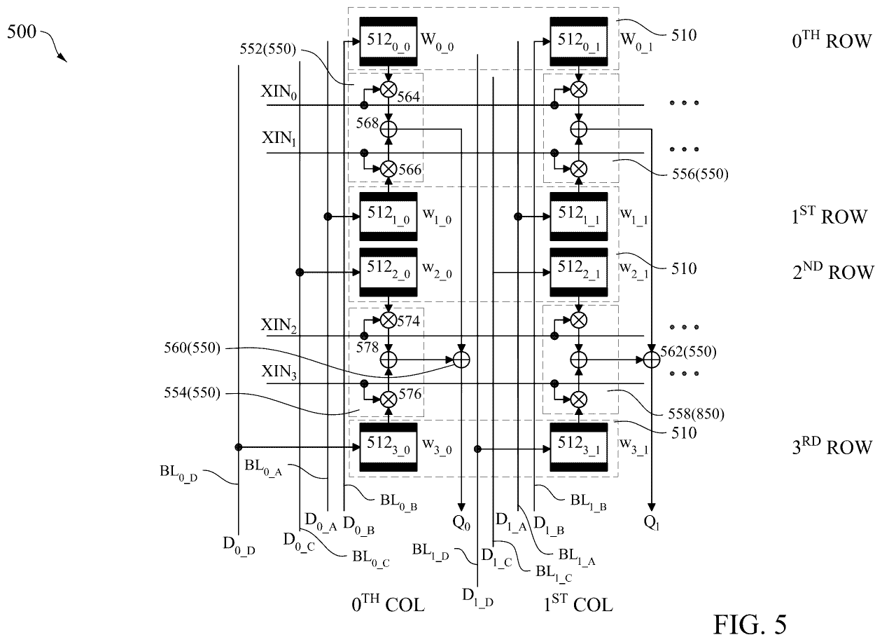

FIG. 5 illustrates a schematic diagram of a part of a memory bank (e.g., one of 206a-206n) including at least one memory array and at least one CIM circuit, which are configured to efficiently output a number of MAC values with a significantly high write bandwidth, in accordance with various embodiments. Hereinafter, the memory bank of FIG. 5 is referred to as a memory bank 500, with its memory array and CIM circuit referred to as memory array 510 and CIM circuit 550, respectively. The memory bank 500 is substantially similar to the memory bank 300 (FIG. 3), except that each column of the memory array 510 includes 4 bit lines, and each of these bit lines can be coupled to 4 memory cells. Accordingly, the following discussion will be focused on the difference.

The memory array 510, in the illustrative example of FIG. 5, can include memory cells 512, e.g., 512_{0_0}, 512_{1_0}, 512_{2_0}, 512_{3_0}, 512_{0_1}, 512_{1_1}, 512_{2_1}, and 512_{3_1}, which are arranged over 2 columns (0^{th} column and 1^{st} column) and 4 rows (0^{th} row, 1^{st} row, 2^{nd} row, and 3^{rd} row). Each of the memory cells can be configured as an SRAM cell, a DRAM cell, or other memory cell type capable of storing a data element. For example, each of the memory cells can store a weight data element, and the respective weight data elements of multiple memory cells along each column can be concurrently updated through the multiple bit lines of that column.

In some embodiments, each of the columns includes 4 bit lines, and each of these 4 bit lines is operatively coupled to 4 memory cells along that column. For example, in FIG. 5, the 0^{th} column includes bit lines BL_{0_A}, BL_{0_B}, BL_{0_C}, and BL_{0_D}, where the bit line BL_{0_A} is operatively coupled to the memory cell 512_{1_0} and other three memory cells 512 (not shown in FIG. 5), the bit line BL_{0_B} is operatively coupled to the memory cell 512_{0_0} and other three memory cells 512 (not shown in FIG. 5), the bit line BL_{0_C} is operatively coupled to the memory cells 512_{2_0} and other three memory cells 512 (not shown in FIG. 5), and the bit line BL_{0_D} is operatively coupled to the memory cells 512_{3_0} and other three memory cells 512 (not shown in FIG. 5). Still, in FIG. 5, the 1^{st} column includes bit lines BL_{1_A}, BL_{1_B}, BL_{1_C}, and BL_{1_D}, where the bit line BL_{1_A} is operatively coupled to the memory cell 512_{1_1} and other three memory cells 512 (not shown in FIG. 5), the bit line BL_{1_B} is operatively coupled to the memory cell 512_{0_1} and other three memory cells 512 (not shown in FIG. 5), the bit line BL_{1_C} is operatively coupled to the memory cells 512_{2_1} and other three memory cells 512 (not shown in FIG. 5), and the bit line BL_{1_D} is operatively coupled to the memory cells 512_{3_1} and other three memory cells 512 (not shown in FIG. 5). Further, in some embodiments, the memory cells coupled to the same bit line may be alternately arranged with respect to the memory cells coupled to the other bit lines. Stated another way, the memory cells coupled to the same bit line may not be arranged in adjacent rows.

In some embodiments, the bit lines are each configured to apply a data element (e.g., a weight data element) concurrently to the coupled memory cells, causing the memory cells to be concurrently updated with the latest data element. As such, a write bandwidth of the memory bank 500 (or the corresponding memory circuit as a whole) can be greatly improved. For example, the bit line BL_{0_A} can apply a data element D_{0_A} to the memory cells 512_{1_0} (1^{st} row) and other three memory cells 512 that may be disposed in 5^{th} row, 9^{th} row, and 13^{th} row, respectively (not shown); the bit line BL_{0_B} can apply a data element D_{0_B} to the memory cells 512_{0_0} (0^{th} row), and other three memory cells 512 that may be disposed in 4^{th} row, 8^{th} row, and 12^{th} row, respectively (not shown); the bit line BL_{0_C} can apply a data element D_{0_C} to the memory cells 512_{2_0} (2^{nd} row), and other three memory cells 512 that may be disposed in 6^{th} row, 10^{th} row, and 14^{th} row, respectively (not shown); and the bit line BL_{0_D} can apply a data element D_{0_D} to the memory cells 512_{3_1} (3^{rd} row), and other three memory cells 512 that may be disposed in 7^{th} row, 11^{th} row, and 15^{th} row, respectively (not shown).

As such, weight data elements W_{0_0}, W_{1_0}, W_{2_0}, and W_{3_0} respectively stored by the memory cells 512_{0_0}, 512_{1_0}, 512_{2_0}, and 512_{3_0} can be updated to D_{0_B}, D_{0_A}, D_{0_c}, and D_{0_A}. Further, at least the update on the memory cells 512_{0_0} and other three memory cells 512 coupled to the bit line BL_{0_B} along the 0^{th} column can concurrently occur; the update on the memory cell 512_{1_0} and other three memory cells 512 coupled to the bit line BL_{0_A} along the 0^{th} column can concurrently occur; the update on the memory cell 512_{2_0} and other three memory cells 512 coupled to the bit line BL_{0_C} along the 0^{th} column can concurrently occur; and the update on the memory cell 512_{3_0} and other three memory cells 512 coupled to the bit line BL_{0_D} along the 0^{th} column can concurrently occur. Similarly, the bit lines BL_{1_A} can apply a data element D_{1_A} to the memory cells 512_{1_1} and other three memory cells 512 along the 1^{st} column; the bit line BL_{1_B} can apply a data element D_{1_B} to the memory cells 512_{0_1} and other three memory cells 512 along the 1^{st} column; the bit line BL_{1_C} can apply a data element D_{1_C} to the memory cells 512_{2_1} and other three memory cells 512 along the 1^{st} column; and the bit line BL_{1_D} can apply a data element D_{1_D} to the memory cells 512_{3_1} and other three memory cells 512 along the 1^{st} column.

The CIM circuit 550, in the illustrative example of FIG. 5, can include a number of computation elements 552, 554, 556, and 558. Each of the computation elements 552 to 558 may include at least two multipliers and one adder. A first one of the multipliers is configured to multiply a first weight data element retrieved from a first memory cell with a first input data element to generate a first product, a second one of the multipliers is configured to multiply a second weight data element retrieved from a second memory cell with a second input data element to generate a second product, and the adder is configured to sum up the first and second product to generate a MAC value. In some embodiments, the first and second multipliers may be coupled to the memory cells, the weight data elements of which are updated through the different bit lines. Further, the CIM circuit 550 can include a number of additional adders (e.g., 560, 562, etc.), each of which corresponds to a respective column of the memory array 510. This additional adder can sum up the MAC values respectively generated by the different computation elements along the same column.

For example, the computation element 552 includes multipliers 564 and 566, and an adder 568. The multiplier 564 can multiply the weight data element W_{0_0} stored in the memory cell 512_{0_0} by input data element XIN₀ to generate a first product, the multiplier 566 can multiply the weight data element W_{1_0} stored in the memory cell 512_{1_0} by input data element XIN₁ to generate a second product, and the adder 568 can sum up the first and second products to generate a first MAC value. Similarly, the computation element 554 includes multipliers 574 and 576, and an adder 578. The multiplier 574 can multiply the weight data element W_{2_0} stored in the memory cell 512_{2_0} by input data element XIN₂ to generate a third product, the multiplier 576 can multiply the weight data element W_{3_0} stored in the memory cell 512_{3_0} by input data element XIN₃ to generate a fourth product, and the adder 578 can sum up the third and fourth products to generate a second MAC value.

Upon at least the first and second MAC values being generated by the computation elements 552 and 554, respectively, the additional adder 560 can sum up the first and second MAC values to generate an output Q₀ which may be a partial sum. In some embodiments, the additional adder 560 can generate the output Q₀ by adding the MAC values generated by other computation elements coupled to the 0^{th} column. Following the same principle, each of the other columns of the memory array 510, together with one or more corresponding computation elements of the CIM circuit 550, can generate a respective output (partial sum) Q. For example, the 1^{st} column can cause a respective output (partial sum) Q₁ to be generated by at least the additional adder 562. Although not shown, it should be understood that the CIM circuit 550 can include at least yet another adder to sum up those partial sums from respective columns (e.g., Q₀, Q₁, etc.) to generate another partial sum.

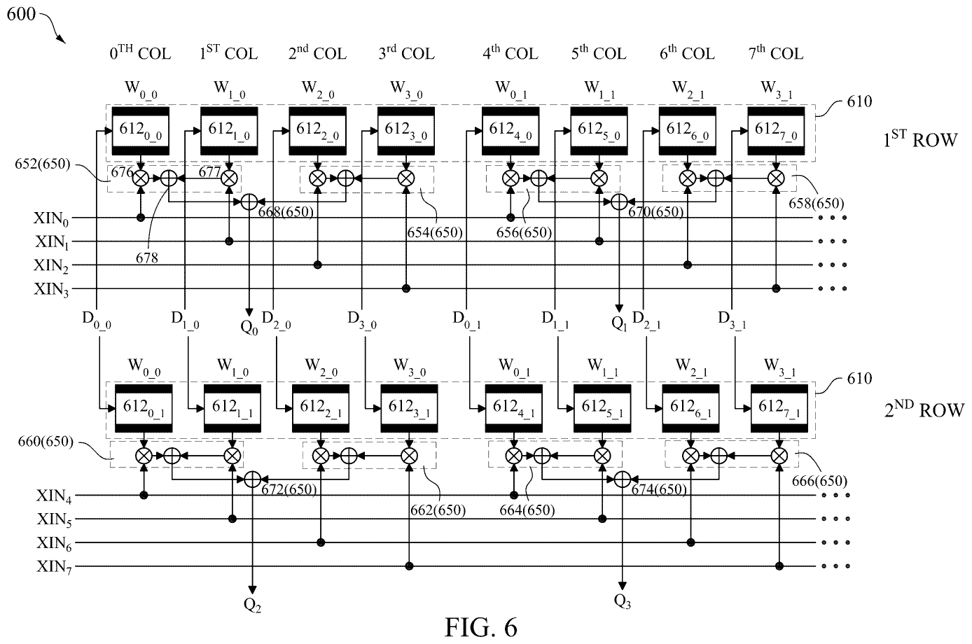

FIG. 6 illustrates a schematic diagram of a part of a memory bank (e.g., one of 206a-206n) including at least one memory array and at least one CIM circuit, which are configured to efficiently output a number of MAC values with a significantly high write bandwidth, in accordance with various other embodiments. Hereinafter, the memory bank of FIG. 6 is referred to as a memory bank 600, with its memory array and CIM circuit referred to as memory array 610 and CIM circuit 650, respectively. It should be understood that the memory bank 600 is simplified for illustration purposes. Thus, memory bank 600 can include any of various other components, while remaining within the scope of present disclosure.

The memory array 610, in the illustrative example of FIG. 6, can include memory cells 612, e.g., 612_{0_0}, 612_{1_0}, 612_{0_1}, 612_{1_1}, 612_{0_2}, 612_{1_2}, 612_{0_3}, 612_{1_3}, 612_{0_4}, 612_{1_4}, 612_{0_5}, 612_{1_1}, 612_{0_6}, 612_{1_6}, 612_{0_7}, and 612_{1_7}, which are arranged over 8 columns (0^{th} column, 1^{st} column, 2^{nd} column, 3^{rd} column, 4^{th} column, 5^{th} column, 6^{th} column, and 7^{th} column) and 2 rows (0^{th} row and 1^{st} row). Each of the memory cells can be configured as an SRAM cell, a DRAM cell, or other memory cell type capable of storing a data element. For example, each of the memory cells can store a weight data element, and the respective weight data elements of multiple memory cells along each column can be concurrently updated through the multiple bit lines of that column.

In some embodiments, each of the columns includes 1 bit line, and the bit line is operatively coupled to a plural number of memory cells along that column. For example, in FIG. 6, the 0^{th} column includes bit lines BL₀, where the bit line BL₀ is operatively coupled to the memory cells 612_{0_0} and 612_{1_0}; the 1^{st} column includes bit lines BL₁, where the bit line BL₁ is operatively coupled to the memory cells 612_{0_1} and 612_{1_1}; the 2^{nd} column includes bit lines BL₂, where the bit line BL₂ is operatively coupled to the memory cells 612_{0_2} and 612_{1_2}; the 3^{rd} column includes bit lines BL₃, where the bit line BL₃ is operatively coupled to the memory cells 612_{0_3} and 612_{1_3}; the 4^{th} column includes bit lines BL₄, where the bit line BL₄ is operatively coupled to the memory cells 612_{0_4} and 612_{1_4}; the 5^{th} column includes bit lines BL₅, where the bit line BL₅ is operatively coupled to the memory cells 612_{0_5} and 612_{1_5}; the 6^{th} column includes bit lines BL₆, where the bit line BL₆ is operatively coupled to the memory cells 612_{0_6} and 612_{1_6}; and the 7^{th} column includes bit lines BL₇, where the bit line BL₇ is operatively coupled to the memory cells 612_{0_7} and 612_{1_7}.

In some embodiments, the bit lines are each configured to apply a data element (e.g., a weight data element) concurrently to the coupled memory cells, causing the memory cells to be concurrently updated with the latest data element. As such, a write bandwidth of the memory bank 600 (or the corresponding memory circuit as a whole) can be greatly improved. For example, the bit line BL₀ can concurrently apply a data element D_{0_0} to the memory cells 612_{0_0} (0^{th} row) and 612_{1_0} (1^{st} row); the bit line BL₁ can concurrently apply a data element D_{1_0} to the memory cells 612_{0_1} (0^{th} row) and 612_{1_1} (1^{st} row); the bit line BL₂ can concurrently apply a data element D_{2_0} to the memory cells 612_{0_2} (0^{th} row) and 612_{1_2} (1^{st} row); the bit line BL₃ can concurrently apply a data element D_{3_0} to the memory cells 612_{0_3} (0^{th} row) and 612_{1_3} (1^{st} row); the bit line BL₄ can concurrently apply a data element D_{0_1} to the memory cells 612_{0_4} (0^{th} row) and 612_{1_4} (1^{st} row); the bit line BL₅ can concurrently apply a data element D_{1_1} to the memory cells 612_{0_5} (0^{th} row) and 612_{1_5} (1^{st} row); the bit line BL₆ can concurrently apply a data element D_{2_1} to the memory cells 612_{0_6} (0^{th} row) and 612_{1_6} (1^{st} row); and the bit line BL₇ can concurrently apply a data element D_{3_1} to the memory cells 612_{0_7} (0^{th} row) and 612_{1_7} (1^{st} row).

As such, weight data element W_{0_0} commonly stored by the memory cells 612_{0_0} and 612_{1_0} can be updated to D_{0_0}; weight data element W_{1_0} commonly stored by the memory cells 612_{0_1} and 612_{1_1} can be updated to D_{1_0}; weight data element W_{2_0} commonly stored by the memory cells 612_{0_2} and 612_{1_2} can be updated to D_{2_0}; weight data element W_{0_1} commonly stored by the memory cells 612_{0_4} and 612_{1_4} can be updated to D_{0_1}; weight data element W_{1_1} commonly stored by the memory cells 612_{0_5} and 612_{5_0} can be updated to D_{1_1}; weight data element W_{2_1} commonly stored by the memory cells 612_{0_6} and 612_{6_0} can be updated to D_{2_1}; and weight data element W_{3_1} commonly stored by the memory cells 612_{0_7} and 612_{1_7} can be updated to D_{3_1}.

The CIM circuit 650, in the illustrative example of FIG. 6, can include a number of computation elements 652, 654, 656, 658, 660, 662, 664, and 666. Each of the computation elements 652 to 666 may include at least two multipliers and one adder. A first one of the multipliers is configured to multiply a first weight data element retrieved from a first memory cell with a first input data element to generate a first product, a second one of the multipliers is configured to multiply a second weight data element retrieved from a second memory cell with a second input data element to generate a second product, and the adder is configured to sum up the first and second product to generate a MAC value. In some embodiments, the first and second multipliers may be coupled to the memory cells, the weight data elements of which are updated through the different bit lines. Further, the CIM circuit 650 can include a number of additional adders (e.g., 668, 670, 672, 674, etc.), each of which corresponds to a respective set of columns (e.g., 4 columns) of the memory array 610. This additional adder can sum up the MAC values respectively generated by the computation elements across the set of columns.

As a representative example, the computation element 652 includes multipliers 676 and 677, and an adder 678. The multiplier 676 can multiply the weight data element W_{0_0} stored in the memory cell 612_{0_0} by input data element XIN₀ to generate a first product, the multiplier 677 can multiply the weight data element W_{1_0} stored in the memory cell 612_{0_1} by input data element XIN₁ to generate a second product, and the adder 678 can sum up the first and second products to generate a first MAC value. Similarly, the computation element 654 includes multipliers 679 and 680, and an adder 681. The multiplier 679 can multiply the weight data element W_{2_0} stored in the memory cell 612_{0_2} by input data element XIN₂ to generate a third product, the multiplier 680 can multiply the weight data element W_{3_0} stored in the memory cell 612_{0_3} by input data element XIN₃ to generate a fourth product, and the adder 681 can sum up the third and fourth products to generate a second MAC value.

Upon at least the first and second MAC values being generated by the computation elements 652 and 654, respectively, the additional adder 668 can sum up the first and second MAC values to generate an output Q₀ which may be a partial sum. In some embodiments, the additional adder 668 can generate the output Q₀ by adding the MAC values generated by a corresponding pair of computation elements coupled to the 0^{th} row and to the 0^{th} to 3^{rd} columns. Following the same principle, each of the other columns and/or other rows of the memory array 610, together with one or more corresponding computation elements of the CIM circuit 650, can generate a respective output (partial sum) Q.

For example, the 1^{st} row and the 4^{th} to 7^{th} columns can cause a respective output (partial sum) Q₁ to be generated based on the input data elements XIN₀ to XIN₃ and the weight data elements W_{0_1}, W_{1_1}, W_{2_1}, and W_{3_1}; the 2^{nd} row and the 0^{th} to 3^{rd} columns can cause a respective output (partial sum) Q₂ to be generated based on input data elements XIN₄ to XIN₇ and the weight data elements W_{0_0}, W_{1_0}, W_{2_0}, and W_{3_0}; and the 2^{nd} row and the 4^{th} to 4^{th} columns can cause a respective output (partial sum) Q₃ to be generated based on the input data elements XIN₄ to XIN₇ and the weight data elements W_{0_1}, W_{1_1}, W_{2_1}, and W_{3_1}. Although not shown, it should be understood that the CIM circuit 650 can include at least yet another adder to sum up those partial sums from respective columns/rows (e.g., Q₀, Q₁, Q₂, Q₃, etc.) to generate another partial sum.

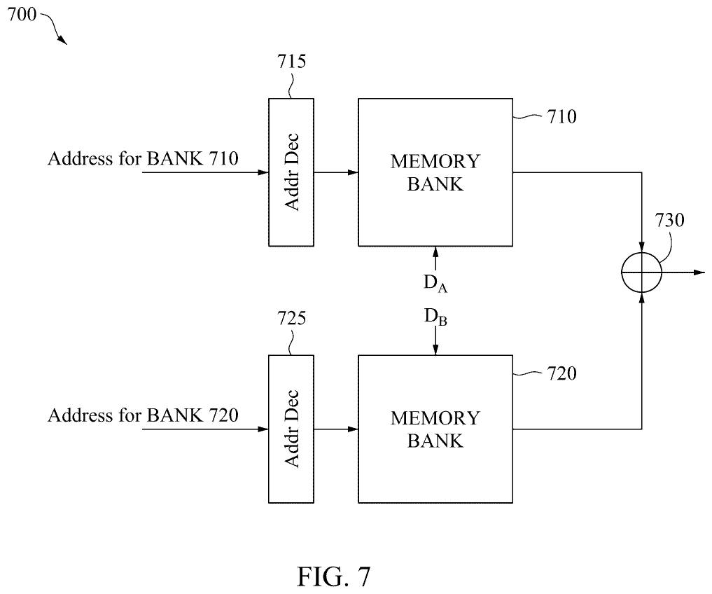

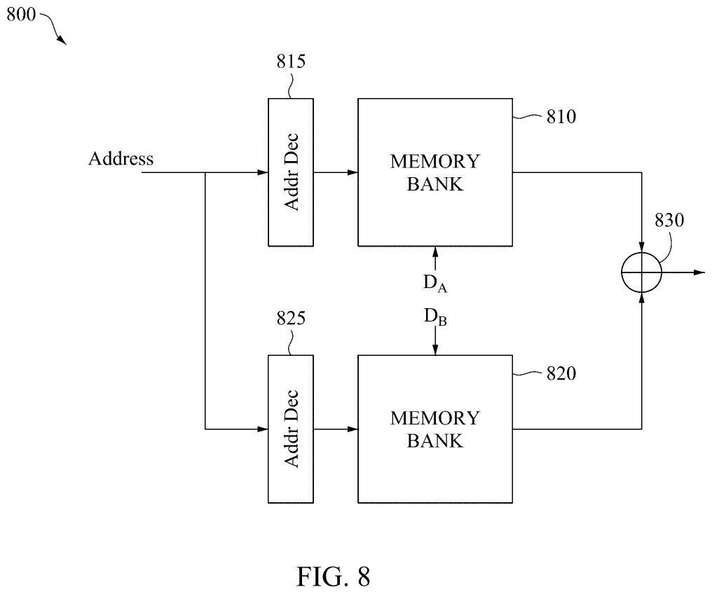

Although the above-discussed examples (e.g., FIGS. 3-6) are directed to concurrently updating (or programming) the weight data elements stored by multiple memory cells of a single memory bank, it should be understood that the technique or system, as disclosed herein, is not limited to a single memory bank. FIG. 7 and FIG. 8 illustrate block diagrams of memory systems 700 and 800, respectively, where the memory systems 700-800 each include multiple memory banks, the weight data elements of which can be concurrently updated, in some embodiments.

In FIG. 7, the memory system 700 includes memory banks 710 and 720, which are coupled to address decoders 715 and 725, respectively. The address decoders 715 and 725 are configured to receive address signals, respectively. Upon the address decoders 715 and 725 decoding the respective address signals, data elements D_{A} and D_{B} can be concurrently updated to the weight data elements stored by the memory cells of the memory banks 710 and 720, respectively. The memory system 700 can include at least one adder 730 to sum MAC values respectively generated from the memory banks 710 and 720. In FIG. 8, the memory system 800 includes memory banks 810 and 820, which are coupled to address decoders 815 and 825, respectively. The address decoders 815 and 825 are configured to receive a common address signal. Upon the address decoders 815 and 825 decoding respective portions of the address signal, data elements D_{A} and D_{B} can be concurrently updated to the weight data elements stored by the memory cells of the memory banks 810 and 820, respectively. The memory system 800 can include at least one adder 830 to sum MAC values respectively generated from the memory banks 810 and 820. As a non-limiting example, if applying either of the memory system 700 or 800 to the schematic diagram of FIG. 3, the memory cells 312_{0_0}, 312_{0_1}, 312_{2_0}, and 312_{2_1} may be disposed or otherwise arranged in one of the memory banks, while the memory cells 312_{1_0}, 312_{1_1}, 312_{3_0}, and 312_{3_1} may be disposed or otherwise arranged in the other one of the memory banks.

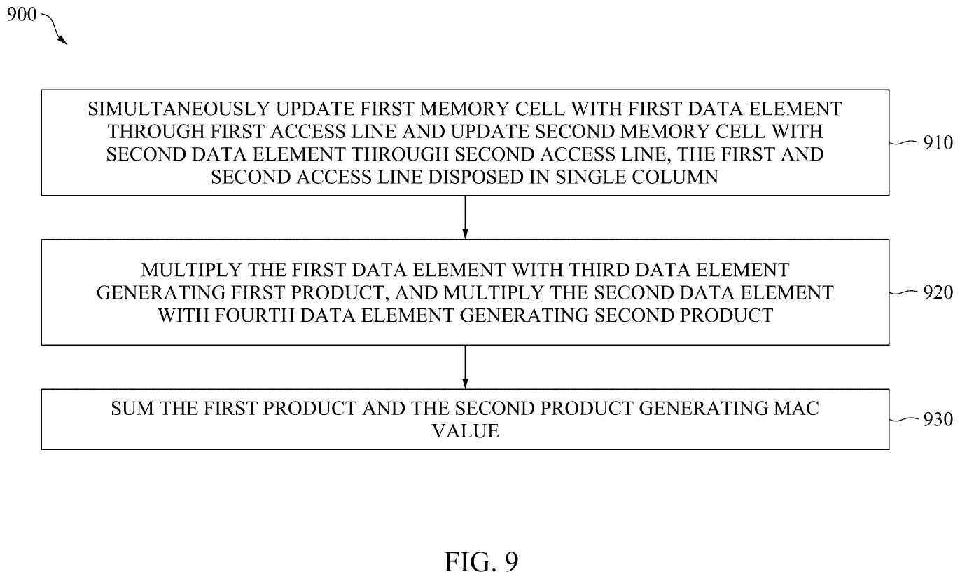

FIG. 9 illustrates a flow chart of an example method 900 for concurrently updating data elements stored by one or more memory banks to generate one or more MAC values, in accordance with some embodiments. For example, at least some of the operations (or steps) of the method 900 can be implemented by at least one of the forgoing figures, and thus, some of the above reference numerals may be again used. It is noted that the method 900 is merely an example, and is not intended to limit the scope of the present disclosure. Accordingly, it should be understood that additional operations may be provided before, during, and/or after the method 900 of FIG. 9, and that some other operations may only be briefly described herein.

The method 900 starts with operation 910 of simultaneously updating a first memory cell of a memory array with a first data element through a first access line and updating a second memory cell of the memory array with a second data element through a second access line. In some embodiments, the first and second access lines are disposed in a single column of the memory array. In some embodiments, such update operations can concurrently occur through the first and second access lines. Further, the first and second memory cells may be operatively coupled to a common computation element, with at least two multipliers and one adder, that can perform a MAC operation. Using the memory bank 300 of FIG. 3 as a representative example, the data elements D_{0_A} and D_{0_B} can be updated to the memory cells 312_{1_0} and 312_{0_0} through the bit lines BL_{0_B} and BL_{0_A}, respectively. The memory cells 312_{1_0} and 312_{0_0} can store the data elements as the weight data elements W_{1_0} and W_{0_0}, respectively. The memory cells 312_{1_0} and 312_{0_0} can be coupled to the computation element 352 including the multipliers 364-366 and adder 368.

The method 900 continues to operation 920 of multiplying the first data element by a third data element to generate a first product, and multiplying the second data element by a fourth data element to generate a second product. Continuing with the above example, the multiplier 364 of the computation element 352 can receive the input data element XIN₀, and multiply the input data element XIN₀ by the weight data element W_{0_0} (which is retrieved from the memory cell 312_{0_0}) to generate a first product; and the multiplier 366 of the computation element 352 can receive the input data element XIN₁, multiply the input data element XIN₁ by the weight data element W_{1_0} (which is retrieved from the memory cell 312_{1_0}) to generate a second product.

The method 900 continues to operation 930 of summing the first product and the second product to generate a multiply-accumulate (MAC) value. Upon generating the first and second product, a MAC value can be generated by summing up the first and second products. Still with the above example, the adder 368 of the computation element 352 can sum up the first product (generated by the multiplier 364) and the second product (generated by the multiplier 366) to generate a MAC value.

In one aspect of the present disclosure, a memory circuit is disclosed. The memory circuit includes a plurality of memory cells arranged over a plurality of columns and a plurality of rows, wherein each of the plurality of memory cells is configured to store a corresponding one of a plurality of first data elements, wherein each of the columns includes a plural number of access lines; and a plurality of computation elements, wherein each of the plurality of computation elements is configured to generate a multiply-accumulate (MAC) value, the MAC value being formed based on (i) a pair of the first data elements respectively stored by a pair of the memory cells disposed in different ones of the rows and in a corresponding one of the columns and (ii) a pair of a plurality of second data elements. The pair of the first data elements are accessed through the plural access lines of the corresponding column.

In another aspect of the present disclosure, a memory circuit is disclosed. The memory circuit includes a first memory cell configured to store a first data element accessible through a first access line; a second memory cell configured to store a second data element accessible through a second access line, wherein the first access line and the second access line are disposed in a single column, and the first and second memory cells are disposed in a first row and a second row, respectively; and a first computation element configured to generate a first multiply-accumulate (MAC) value calculated based on the first data element, the second data element, a third data element, and a fourth data element.

In yet another aspect of the present disclosure, a method for operating a memory circuit is disclosed. The method includes simultaneously updating a first memory cell of a memory array with a first data element through a first access line and updating a second memory cell of the memory array with a second data element through a second access line, wherein the first and second access lines are disposed in a single column of the memory array. The method includes multiplying the first data element by a third data element to generate a first product, and multiplying the second data element by a fourth data element to generate a second product. The method includes summing the first product and the second product to generate a multiply-accumulate (MAC) value.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., +10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A memory circuit, comprising:
a plurality of memory cells arranged over a plurality of columns and a plurality of rows, wherein each of the plurality of memory cells is configured to store a corresponding one of a plurality of first data elements, wherein each of the columns includes a plural number of access lines; and
a plurality of computation elements, wherein each of the plurality of computation elements is configured to generate a multiply-accumulate (MAC) value, the MAC value being formed based on (i) a pair of the first data elements respectively stored by a pair of the memory cells disposed in different ones of the rows and in a corresponding one of the columns and (ii) a pair of a plurality of second data elements;
wherein the pair of the first data elements are accessed through the plural access lines of the corresponding column.

2. The memory circuit of claim 1, wherein the first data elements each include a weight data element, and the second data elements each include an input data element.

3. The memory circuit of claim 1, wherein the plural number of access lines of each of the columns is equal to 2.

4. The memory circuit of claim 1, wherein the plural number of access lines of each of the columns is equal to 3.

5. The memory circuit of claim 1, wherein the plural number of access lines of each of the columns is equal to 4.

6. The memory circuit of claim 1, wherein each of the computation elements is operatively coupled to a pair of the memory cells disposed in different ones of the rows and a corresponding one of the columns.

7. The memory circuit of claim 1, wherein the access lines each include a bit line.

8. The memory circuit of claim 7, wherein the bit line of each of the columns is configured to access multiple ones of the memory cells disposed in the corresponding column.

9. The memory circuit of claim 1, wherein the pair of the second data elements are provided to the corresponding computation element.

10. The memory circuit of claim 1, wherein each of the computation elements includes at least two multipliers and one adder.

11. The memory circuit of claim 10, wherein a first one of the two multipliers is configured to multiply a first one of the pair of the first data elements by a first one of the pair of the second data elements to generate a first product, a second one of the two multipliers is configured to multiply a second one of the pair of the first data elements by a second one of the pair of the second data elements to generate a second product, and the one adder is configured to sum the first product and the second product.

12. A memory circuit, comprising:
a first memory cell configured to store a first data element accessible through a first access line;
a second memory cell configured to store a second data element accessible through a second access line, wherein the first access line and the second access line are disposed in a single column, and the first and second memory cells are disposed in a first row and a second row, respectively; and
a first computation element configured to generate a first multiply-accumulate (MAC) value calculated based on the first data element, the second data element, a third data element, and a fourth data element.

13. The memory circuit of claim 12, wherein the third data element and the fourth data element are provided to the first computation element.

14. The memory circuit of claim 12, wherein the first and second access lines are each a bit line.

15. The memory circuit of claim 12, further comprising:
a third memory cell configured to store a fifth data element accessible through the first access line;
a fourth memory cell configured to store a sixth data element accessible through the second access line, wherein the third and fourth memory cells are disposed in a third row and a fourth row, respectively; and
a second computation element configured to generate a second MAC value calculated based on the fifth data element, the sixth data element, a seventh data element, and an eighth data element.

16. The memory circuit of claim 15, further comprising an adder, corresponding to the single column, that is configured to sum the first MAC value and the second MAC value.

17. The memory circuit of claim 12, wherein the first and second data elements each include a weight data element, and the third and fourth data elements each include an input data element.

18. A method for operating a memory circuit, comprising:
simultaneously updating a first memory cell of a memory array with a first data element through a first access line and updating a second memory cell of the memory array with a second data element through a second access line, wherein the first and second access lines are disposed in a single column of the memory array;
multiplying the first data element by a third data element to generate a first product, and multiplying the second data element by a fourth data element to generate a second product; and
summing the first product and the second product to generate a multiply-accumulate (MAC) value.

19. The method of claim 18, wherein the first and second data elements each include a weight data element, and the third and fourth data elements each include an input data element.

20. The method of claim 18, wherein the first and second access lines are each a bit line configured to access a plural number of memory cells disposed in the single column.
